(19) United States
(12) Patent Application Publication
(10) Pub. No.: US 2007/0204953 A1
(43) Pub. Date: Sep. 6, 2007

(54) Method for forming structured film as molded by tape die

(76) Inventor: Ching-Bin Lin, Taipei (TW)

Correspondence Address: Ching-Bin Lin, P.O. Box 55-846, Taipei, 104, TW

(21) Appl. No.: 11/357,529

(22) Filed: Feb. 21, 2006

(51) Int. Cl. B29D 31/00; B05D 5/06; B05D 3/12; C08F 2/46

(52) U.S. Cl. 156/242; 156/275.7; 427/162; 427/355; 427/487; 427/384

(57) ABSTRACT

A method for forming structured or micro-structured film comprising the steps of: A. Coating a photocuring or heat-curing adhesive resin layer on a substrate layer; B. Molding or forming or imprinting a structured or micro-structured pattern including prismatic array on the adhesive resin layer by a tape die having the structured pattern preformed on the tape die; and C. Curing the photocuring or heat-curing adhesive resin layer on the substrate layer to obtain a layered film having a structured pattern surface. The structured pattern is formed on the tape, rather than on the rotary die or die roller, to prevent from sticking of the adhesive resin on the roller to prolong the service life of the production equipment and also to ensure a reliable film product quality.

### BACKGROUND OF THE INVENTION

U.S. Patent Application Publication No. US 2005/0134963 A1 disclosed a display including an optical film that has a surface structure, such as a prismatically structured surface for increasing the brightness of the display. The structured surface is bonded to an opposing surface of a second film using a layer of adhesive, by penetrating the structured surface into the adhesive layer to a depth less than a feature height of the structured surface.

A die (1530) of this prior art is provided on a die roller (1532) for forming the structured surface of the optical film. However, partial adhesive may be adhered to the grooves or tips of the die roller to influence the quality of the film product. The costly die roller should always be replaced with a new one, thereby increasing the production cost.

The present inventor has found the drawbacks of the prior art and invented the present method for forming structured film in a more economical way.

### SUMMARY OF THE INVENTION

The object of the present invention is to provide a method for forming structured film comprising the steps of:
A. Coating a photocuring (or photosensitive) or heat-curing adhesive resin layer on a substrate layer;
B. Forming or molding or imprinting a structured or micro-structured pattern including prismatic array on the adhesive resin layer by a tape die having said structured pattern preformed on said tape die; and
C. Curing said photocuring or heat-curing adhesive resin layer on said substrate layer to obtain a layered film having said structured pattern firmly formed thereon.

### BRIEF DESCRIPTION OF THE DRAWINGS

FIG. 1 is a flow sheet showing the process for making the structured film in accordance with the present invention.

FIG. 2 shows a second preferred embodiment of the present invention as modified from FIG. 1.

FIG. 3 is a cross sectional drawing of a backing roller as viewed from 3-3 direction of FIG. 2 by omitting a reflector in the backing roller.

FIG. 4 shows a third preferred embodiment of the present invention.

FIG. 5 shows a fourth preferred embodiment of the present invention.

FIG. 6 shows a fifth preferred embodiment of the present invention.

### DETAILED DESCRIPTION

A method for forming structured or micro-structured film of the present invention comprises the steps of:
A. Coating a photocuring or heat-curing adhesive resin layer on a substrate layer;
B. Molding or forming or imprinting a structured (or micro-structured) pattern including prismatic array on said adhesive resin layer by a tape die having said structured pattern preformed on said tape die; and
C. Curing said photocuring or heat-curing adhesive resin layer on said substrate layer to obtain a layered film having said structured pattern formed thereon.

In accordance with the present invention, the layered film product may include an optical film having prismatic array or other brightness enhancing structured surface (or surfaces) formed on the upper portion of the layered film. So, the present invention may be provided for making optical films to be used in LCD, and other electronic, computer and electric items.

The tape die includes the structured (or micro-structured) pattern formed on a tape, a belt or a strap which is movably, rotatably or operatively driven for forming or molding the pattern onto the photocuring adhesion resin layer. The pattern is formed on a tape, rather than on a rotary die or a roller, to prevent from adhesion of the adhesive on the roller or rotary die and to also prevent from sticking of other process equipments, thereby enhancing the film product quality.

The photocuring or photosensitive adhesive resin as used in this invention may include UV curable resin and may comprise the following ingredients: diluters, oligomers, monomers, photoinitials and additives as cross linked.

The adhesive resin may comprise a cross-linking polymer matrix having a refractive index of at least 1.50 and being durable when cured. The cross-linking polymers may include acrylate, methyl acrylate, bromides, alkyl phenyl acrylate (including: 4,6-dibromo-2-sec-butyl phenyl acrylate), methyl styrene monomer, brominated epoxy diacrylate, 2-phenoxyethyl acrylate hexa-functional aromatic urethane acrylate oligomer.

The diluter is provided to decrease the viscosity of the polymer to prevent from the occurrence of gas bubbles, thereby obtaining a perfect micro-structure. The diluters, as always used, may include mono-functional or di-functional monomer.

The photoinitial includes: organic peroxides, azo compounds, quinines, nitro compounds, acryl halides, hydrazones, mercapto compounds, phrylium compounds, imidazoles, chlorotriazines, benzoin, benzoin alkyl ethers, di-ketones, phenones, etc.

The optical layer or micro-structured layer of optical film may be made of polymers having high refractive index such as made of methyl acrylate monomer, halide monomer and other monomers. Those free radical monomers and oligomers with high activity are used recently. The acrylic acid having high activity may also be widely used.

The synthetic polymer as used in this invention may include additive, such as: surfactant, anti-static electricity agent, etc. The surfactant such as fluorosurfactant may be provided to reduce the surface tension of the synthetic polymer, to improve the wetting property, and to enhance a smooth coating operation or coating quality.

The preferably used photocuring resin (including UV curable resin, or UV curable resin for hard coat) may include low surface energy molecules.

The following silanes are the typical examples of low surface energy molecules: 1H,1H,2H,2H-perfluorooctyl triethoxysilane fluorinated silane; tridecafluoro-1,1,2,2-tetrahydrooctyl richlorosi lane (F13-TCS); Octadecyltrichlorosilane (CH₃(CH₂)₁₇SiCl₃,OTS); Alkylchlorosilanes (CH₃(CH₂)ₙ₋₁SiCl₃); Propyltrichlorosilane (CH₃CH₂CH₂SiCl₃,PTCS); (3,3,3-trifluoropropyl trichlorosilane (CF₃CF₂CH₂SiCl₃,FPTCS); dimethyldichlorosilane (DDMS); tridecafluoro-1,1,2,2,-tetrahydrooctyl trichlorosilane (FOTS); and heptadecafluoro-1,1,2,2-tetrahydrodecyltrichlorosilane (FDTS).

The substrate layer as used in the present invention should have a good transparency, proper structural strength and optimum temperature resistance or anti-aging or anti-scratching properties to be applied for optical products.

The substrate layer may be made of the following most popularly used plastic or composite materials: Polyethylene Terephthalate (PET), polycarbonate (PC), styrene-acrylonitrile, cellulose acetate butyrate, cellulose acetate propionate, cellulose triacetate, polyether sulfone, polymethyl methacrylate, polyurethane, polyester, polyvinyl chloride, polystyrene, polyethylene naphthalate, copolymers, mixed naphthalene dicarboxylic acids, polycyclo-olefins and glass. The substrate materials may also be selected from their mixtures or synthetic materials. The substrate layer may be multiplayer including suspending dispersed phase or continuous phase, not limited in this invention.

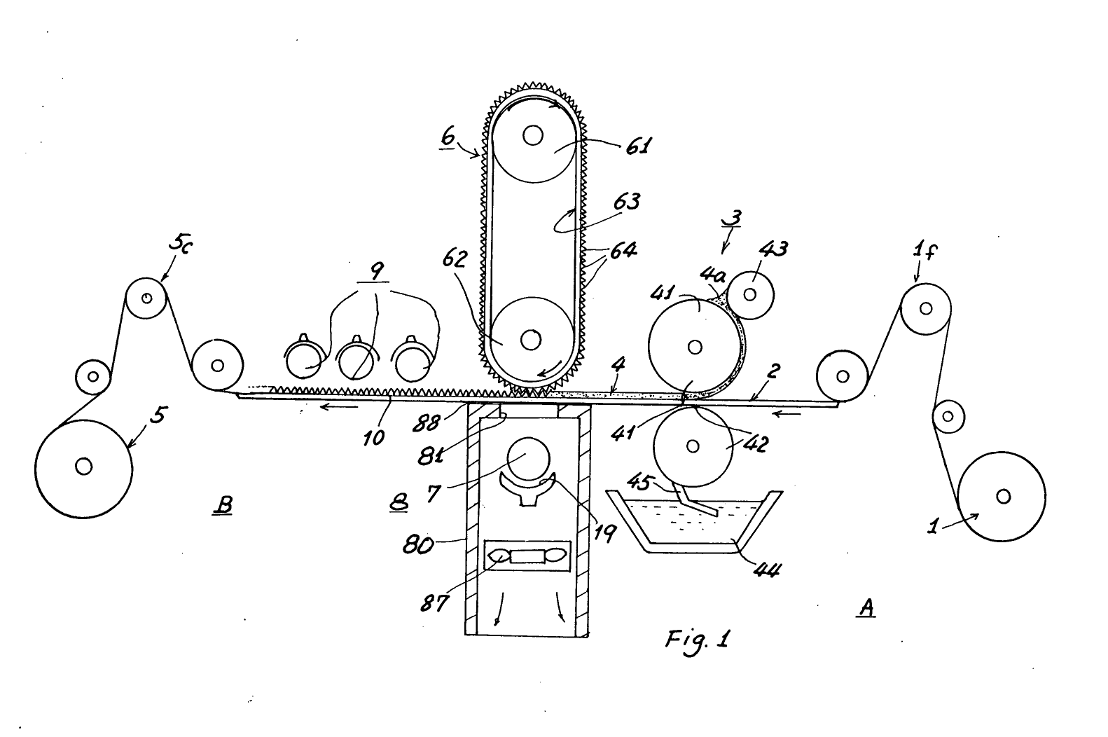

A systematic equipment for making the structured film of the present invention is shown in FIG. 1, which is a first preferred embodiment of the present invention.

The photocuring adhesive resin (including UV curable resin) 4a is coated on the substrate layer 2 as stripped from the substrate roll 1 through a plurality of feeding rollers 1f as shown in Side A of FIG. 1.

The substrate layer 2 may use the transparent plastic film materials such as PET, PC, styrene-acrylonitrile as aforementioned.

The substrate layer 2 is fed into the coating means 3 to be coated with the photocuring adhesive resin 4a to form the photocuring adhesive resin layer 4 on the substrate layer 2.

The adhesive resin layer 4 is then molded or formed with structured or prismatic pattern by the forming means 6 as backed by a backing means 8.

During the molding or forming or imprinting step of the structured or prismatic pattern on the resin layer, a primary curing UV lamp 7 is provided for primarily curing the adhesive resin layer 4 (to inhibit the flowability of the resin 4a) on the substrate layer 2. Then, a secondary curing UV lamp (or lamps) is (or are) provided for finally curing the adhesive resin layer 4 to form a cured layered film with structured, micro-structured or prismatic surface formed on an upper portion of the layered film and to firmly bond the adhesive resin layer 4 with the substrate layer 2. The primary and secondary curing UV lamps 7, 9 may be defined as a “curing means”.

The layered (or laminated) film is then taken up by a windup roll 5 through a plurality of collective guiding rollers 5c as disposed on Side B as shown in FIG. 1.

The coating means 3 includes: a coating roller 41, and an anvil roller 42 cooperatively rotatably sandwiching the substrate layer 2 therebetween for coating the photocuring adhesive resin 4a on the substrate layer 2 when forwardly fed between the coating roller 41 and the anvil roller 42 to thereby coat a photocuring adhesive resin layer 4 on the substrate layer 2.

An aperture between the two rollers 41, 42 may be adjusted, depending upon the practical requirement.

An adhesive distributing roller 43 is rotatably juxtapositioned to the coating roller 41 for controlling or shaving the adhesive thickness when applying the adhesive resin 4a on the coating roller 41 to control the thickness of the adhesive resin layer 4 on the substrate layer 2.

The adhesive distributing roller 43 is rotated in a direction opposite to that of the coating roller 41.

The coating means 3 further includes: an adhesive collector 44 disposed below the anvil roller 42 and under the coating roller 41 for collecting any excess adhesive 4a dropping downwardly from the rollers 42, 41.

A scraper 45 is provided to contact a periphery of the anvil roller 42 in order to scrape the adhesive 4a as accumulated on the roller 42 to be drained and collected in the adhesive collector 44.

The forming means 6 includes: a forming roller 62 approximating the adhesive resin layer 4 and the substrate layer 2, a conjugated roller 61 cooperatively coupled to the forming roller 62 and positioned distally to the forming roller 62, an endless tape die 63 having structured (or micro-structured or prismatic) pattern 64 preformed on the tape die 63 and recyclably wound about the forming roller 62 and the conjugated roller 61, whereby upon a driving of anyone roller 61 or 62, the tape die 63 will be synchronously driven to allow the structured pattern 64 on the tape die 63 to press or print the photocuring adhesive resin layer 4 on the substrate layer 2 to form (or print) the structured pattern (such as prismatic array) on the adhesive resin layer 4, as backed by a backing means 8 adjacent to the substrate layer 2 for retaining the layer 2 when forwardly feeding the substrate layer 2 and the adhesive resin layer 4 in between the forming roller 62 (having the tape die 63 wound thereon) and the backing means 8.

The backing means 8 includes: a backing flat plate 88 juxtapositionally backing the substrate layer 2 and the adhesive resin layer 4 in cooperation with the forming roller 62 having the tape die 63 rotatably wound thereon, so that the backing plate 88 will serve as an “anvil” for backing the substrate layer 2 to form the structured pattern on the adhesive resin layer 4 on the substrate layer 2.

The backing means 8 may include a housing 80 protruding downwardly (or outwardly) from the backing flat plate 88 to encase a primary curing UV lamp 7 within the housing 80, an opening 81 formed in the backing flate plate 88 for radiating the UV light from the UV lamp 7 for primarily curing the adhesive resin 4a on the substrate layer 2 to inhibit the flowability of the adhesive resin and for primarily setting the structured pattern on the adhesive resin layer 4 to prevent from deformation of the primarily cured pattern.

A reflector 19 is provided on the back side of the UV lamp 7 for reflecting the UV light outwardly for radiating towards the layers 4, 2.

A cooling means 87 such as a cooling fan is provided for dissipating heat produced from the lamp 7 to prolong its service life.

The structured pattern 64 stably formed on the tape die 63 should be made of anti-sticking materials for preventing from adhesion by the adhesive resin 4a, being durable for scratching, and firmly bonded to the tape die 63.

The tape die 63 may be made of tape or belt having high mechanical strength, durable for fatigue failure, either of metallic or non-metallic materials.

The photocuring adhesive resin 4a may be transparent or color resin, either in individual or composite form. Upon radiation by different power ratings of ultra-violet light, it may produce different curing or adhesion properties.

The primary UV lamp 7 is provided for primarily curing the adhesive resin 4a to prevent from deformation of the formed pattern by the die 63, 64. Then, the secondary UV lamp 9 further cures the pattern 10 on adhesive resin for firmly setting the pattern of the present invention.

The installation or allocation of the primary and secondary lamps 7, 9 are optionally provided in this invention, not being limited or confined within a specific space or location.

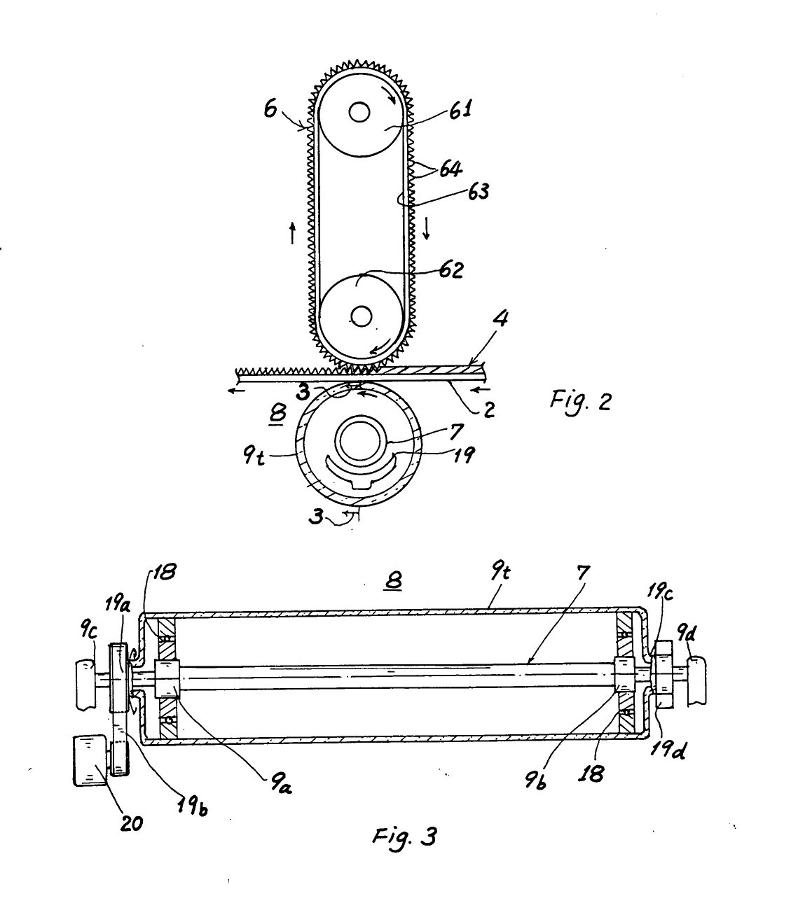

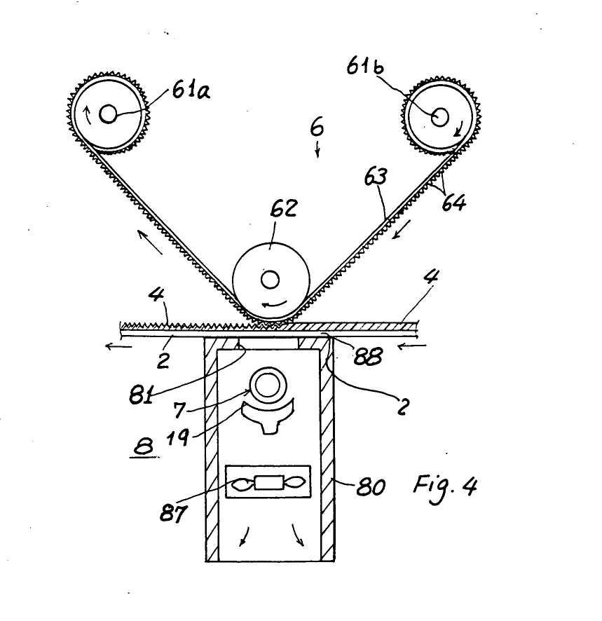

As shown in FIGS. 2 and 3, the backing means 8 as aforementioned may be modified to include: a cylindrical roller 9t, which is transparent or optically transmissive adapted for transmission of UV light therethrough, and rotatably backing the substrate layer 2 in cooperation with the forming roller 62 having the tape die 63 rotatably wound thereon; and a primary curing UV lamp 7 axially secured in the cylindrical roller 9t for radiating UV light towards the substrate layer 2 and the adhesive resin layer 4 in order to primarily cure the adhesive resin 4a having formed with structured pattern thereon.

A reflector 19 is also provided for helping reflection of UV lights upwardly towards the layers 2, 4.

As shown in FIG. 3, the cylindrical roller 9t is a hollow cylinder (such as made of quartz tube) rotatably engaging with the primary curing UV lamp 7 by a pair of bearings 18; having a driving tubular end 19a of the hollow cylinder 9t rotatably driven by a motor 20 through a transmission system 19b (such as a belt or chain) and having another tubular end 19c of the hollow cylinder 9t rotatably mounted on a holder 19d; and having opposite lamp ends 9a, 9b of the lamp 7 respectively secured or fixed to two brackets 9c, 9d as shown in FIG. 3.

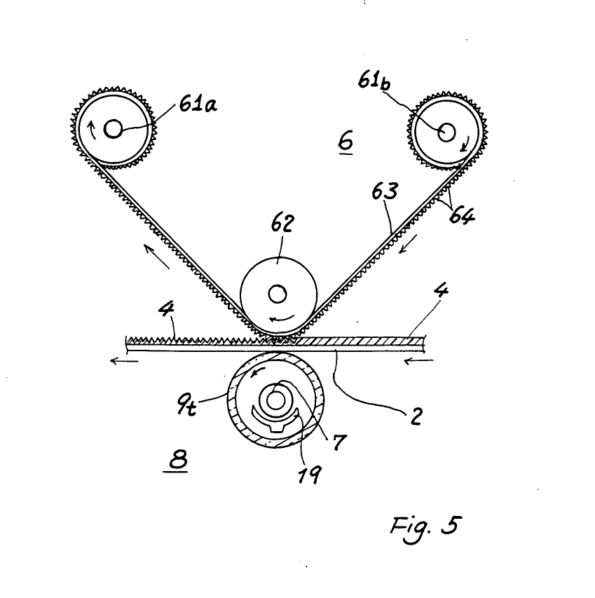

As shown in FIG. 4, the forming means 6 as shown in FIG. 1 has been modified to include: a forming roller 62 approximating the adhesive resin layer 4, a stripping roller 61b operatively stripping the tape die 63, a winding roller 61a operatively receiving and winding the tape die 63, and the tape die 63 having structured pattern 64 preformed thereon and movably wound about the forming roller 62, whereby upon forward moving of the tape die 63, the structured pattern 64 on the tape die 63 will be imprinted or pressed onto the adhesive resin layer 4 as forced by the forming roller 62 to form the structured pattern on the adhesive resin layer 4, as backed by the backing means 8.

Other procedures for making the structured layered film may be referred to that as shown in FIG. 1 and described as aforementioned.

After completely winding the tape die 63 on the winding roller 61a, the tape die 63, formed as a “roll”, may be transferred to the stripping roller 61b for its “re-running” for repeatedly producing the layered films of the present invention.

As shown in FIG. 5, the forming means 6 is the same as that shown in FIG. 4 and the backing means 8 is, however, the same as that as shown in FIG. 2. This is another modification for the process equipments which may be used in the present invention.

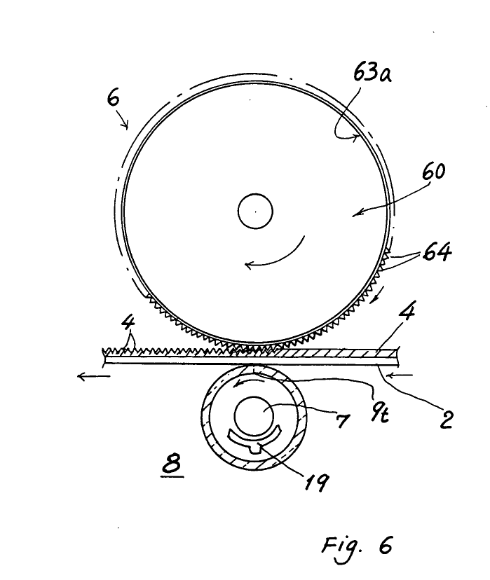

As shown in FIG. 6, the forming means 6 is modified to include: a forming roller 60 having a large diameter, a circularly or cylindrically shaped tape die 63a having an inside diameter generally equal to an outside diameter of the forming roller 60 to snugly wind the tape die 63a about the outside diameter of the forming roller 60, having a structured pattern 64 circumferentially formed on the tape die 63a, whereby upon rotation of the forming roller 60, the tape die 63a having the structured pattern 64 formed on the tape die 63a will print the structured pattern on the adhesive resin layer 4 on the substrate layer 2.

The present invention provides a method for making structured or optical films for preventing adhesion or sticking of adhesive on the die or structured pattern to prolong the service life of the related rollers or equipments and also to enhance the film product quality, thereby being superior to the prior arts.

The present invention may be modified without departing from the spirit and scope of the present invention.

The photocuring adhesive resin as aforementioned may also be replaced with a heat-curing adhesive resin, including the following thermosetting adhesive resin: unsaturated polyester, epoxy resin, phenolic resin, melamine-formaldehyde, furan, polybutadiene, silicon resin, urea-formaldehyde and polyurethane, etc.

I claim:

1. A method for forming structured film comprising the steps of:
A. Coating a curable adhesive resin on a substrate layer to form a curable adhesive resin layer on said substrate layer; said curable adhesive resin selected from the group consisting of a photocuring adhesive resin and a heat-curing adhesive resin;
B. Molding or forming or imprinting a structured pattern on said adhesive resin layer by a tape die having said structured pattern preformed on said tape die; and
C. Curing said curable adhesive resin layer on said substrate layer to obtain a layered film having said structured pattern cured and stably formed on said adhesive resin layer and having said adhesive resin layer firmly bonded with said substrate layer.

2. A method according to claim 1, wherein said layered film is an optical film and said structured pattern includes at least a prismatic array formed on said substrate layer.

3. A method according to claim 1, wherein said structured pattern includes a micro-structured pattern.

4. A method according to claim 1, wherein said tape die includes said structured pattern preformed on a tape for movably or rotatably forming said structured pattern on said adhesive resin layer; said tape die and the structured pattern on said tape die having anti-sticking property for preventing adhesion of the adhesive resin on the structured pattern on the tape die.

5. A method according to claim 1, wherein the step for coating the adhesive resin on said substrate layer is performed by a coating means, which includes: a coating roller, and an anvil roller cooperatively rotatably sandwiching the substrate layer therebetween for coating the curable adhesive resin on the substrate layer when forwardly fed between the coating roller and the anvil roller to thereby coat said adhesive resin layer on the substrate layer.

6. A method according to claim 5, wherein said coating means further includes an adhesive distributing roller rotatably juxtapositioned to the coating roller for controlling adhesive quantity when applying the adhesive resin on the coating roller to control a thickness of the adhesive resin layer on the substrate layer.

7. A method according to claim 5, wherein said coating means further includes: an adhesive collector disposed below the anvil roller and under the coating roller for collecting any adhesive dropping downwardly from said rollers.

8. A method according to claim 7, wherein said coating means further includes a scraper provided to contact a periphery of the anvil roller in order to scrape the adhesive as accumulated on the anvil roller and to drain and collect the adhesive in the adhesive collector.

9. A method according to claim 1, wherein the step for molding or forming or imprinting the structured pattern on the adhesive resin layer is performed by a forming means operatively forming the structured pattern on said adhesive resin layer, as backed by a backing means adjacent to said forming means.

10. A method according to claim 9, wherein said forming means includes a forming roller approximating the adhesive resin layer and the substrate layer, a conjugated roller cooperatively coupled to the forming roller and positioned distally to the forming roller, an endless tape die having structured pattern preformed on the tape die and recyclably wound about the forming roller and the conjugated roller, whereby upon a driving of anyone of said rollers, the tape die will be synchronously driven to allow the structured pattern on the tape die to be pressed or printed on the adhesive resin layer on the substrate layer to form the structured pattern on the adhesive resin layer, as backed by a backing means retaining the substrate layer when forwardly feeding the substrate layer and the adhesive resin layer in between the forming roller having the tape die wound thereon and the backing means.

11. A method according to claim 9, wherein said forming means includes: a forming roller approximating the adhesive resin layer, a stripping roller operatively stripping the tape die, a winding roller operatively receiving and winding the tape die, and the tape die having structured pattern preformed thereon and movably wound about the forming roller, whereby upon forward moving of the tape die, the structured pattern on the tape die will be printed or pressed onto the adhesive resin layer as forced by the forming roller to form the structured pattern on the adhesive resin layer, as backed by the backing means.

12. A method according to claim 9, wherein said forming means includes: a forming roller, a circularly or cylindrically shaped tape die having an inside diameter generally equal to an outside diameter of the forming roller to snugly wind the tape die about the outside diameter of the forming roller, having a structured pattern circumferentially formed on the tape die, whereby upon rotation of the forming roller, the tape die having the structured pattern formed on the tape die will print the structured pattern on the adhesive resin layer on the substrate layer.

13. A method according to claim 1, wherein the step for curing the adhesive resin layer is performed by a curing means, which includes a primary curing device for primarily curing the adhesive resin layer when formed with the structured pattern on said resin layer, and a secondary curing device for secondarily curing the structured pattern on said adhesive resin layer and for bonding said adhesive resin layer with said substrate layer; and wherein said primary curing device is provided within a backing means for backing said substrate layer and said adhesive resin layer when forming the structured pattern on said resin layer by a forming roller of a forming means having a tape die formed with the structured pattern thereon; and each said curing device selected from the group consisting of an UV lamp and a heater.

14. A method according to claim 13, wherein said backing means includes: a backing flat plate juxtapositionally backing the substrate layer and the adhesive resin layer in cooperation with the forming roller having the tape die rotatably wound thereon, so that the backing plate will serve as an anvil for backing the substrate layer to form the structured pattern on the adhesive resin layer on the substrate layer.

15. A method according to claim 14, wherein said backing means include a housing protruding from the backing flat plate to encase a primary curing device within the housing, an opening formed in the backing flate plate for radiating heat or UV light from the primary curing device through the opening for primarily curing the adhesive resin layer on the substrate layer.

16. A method according to claim 13, wherein said backing means includes: a cylindrical roller, which is transparent or optically transmissive adapted for transmission of UV light therethrough, and rotatably backing the substrate layer in cooperation with the forming roller having the tape die rotatably wound thereon; and said primary curing device being an UV lamp axially secured in the cylindrical roller for radiating UV light towards the substrate layer and the adhesive resin layer in order to primarily cure the adhesive resin layer having formed with structured pattern thereon.
